(19) United States
(12) Patent Application Publication
(10) Pub. No.: US 2025/0069626 A1
(43) Pub. Date: Feb. 27, 2025

(54) MAGNETIC TAPE CARTRIDGE AND MANUFACTURING METHOD OF MAGNETIC TAPE CARTRIDGE

(71) Applicant: FUJIFILM CORPORATION, Tokyo (JP)

(72) Inventor: Yosuke SUMIYA, Kanagawa (JP)

(21) Appl. No.: 18/791,466

(22) Filed: Aug. 1, 2024

(30) Foreign Application Priority Data
Aug. 23, 2023 (JP) 2023-135899

(51) Int. Cl. G11B 33/02; G11B 5/008

(52) U.S. Cl. CPC G11B 33/022; G11B 5/00813

(57) ABSTRACT

A magnetic tape cartridge includes a magnetic tape and a case that is a housing of which a first case member and a second case member are fastened to each other to form an internal space in which a magnetic tape is accommodable, the case including a first fastening hole to which a first fastening member fastening the first case member and the second case member to each other is attached and a second fastening hole to which a second fastening member that is attached through a method different from a method through which the first fastening member is attached and that fastens the first case member and the second case member to each other for suppression of decomposition of the housing is attachable.

### CROSS-REFERENCE TO RELATED APPLICATION

This application claims priority from Japanese Patent Application No. 2023-135899, filed on Aug. 23, 2023, the disclosure of which is incorporated by reference herein in its entirety.

### BACKGROUND

### Field of the Invention

The present disclosed technology relates to a magnetic tape cartridge and a manufacturing method of a magnetic tape cartridge.

### Related Art

Disclosed in JP1997-91923A (JP-H9-91923A) is a tape cassette consisting of an upper shell, a lower shell, a tape-shaped recording medium encompassed by both of the shells, and a shell bonding unit that bonds both of the shells to each other, the shell bonding unit being composed of a boss portion and a pressing pin partially deformed.

Disclosed in JP2005-135486A is a recording medium cartridge including a case that accommodates a recording medium with an upper case and a lower case bonded to each other by a plurality of screws, in which paint is applied to a head portion of at least one of the plurality of screws bonding the upper case and the lower case to each other.

Disclosed in JP2003-123342A is a write-once-read-many magnetic tape system that includes a tape cartridge including a magnetic tape suitable for recording and storage of electronic data and an electronic memory device and a tape drive receiving the tape cartridge and reads the memory device, the drive operating only in a write-once-read-many mode in accordance with information read from the memory device.

### SUMMARY

One embodiment according to the present disclosed technology provides a magnetic tape cartridge and a manufacturing method of a magnetic tape cartridge with which it is possible to selectively impart a decomposition suppressing effect in accordance with the needs of a user.

A first aspect according to the present disclosed technology provides a magnetic tape cartridge including a magnetic tape and a case that is a housing of which a first case member and a second case member are fastened to each other to form an internal space in which a magnetic tape is accommodable, the case including a first fastening hole to which a first fastening member fastening the first case member and the second case member to each other is attached and a second fastening hole to which a second fastening member that is attached through a method different from a method through which the first fastening member is attached and that fastens the first case member and the second case member to each other for suppression of decomposition of the housing is attachable.

A second aspect according to the present disclosed technology provides the magnetic tape cartridge according to the first aspect, in which a plurality of the first fastening holes are formed, and at least one first fastening hole is formed at each of positions corresponding to four corners of the housing.

A third aspect according to the present disclosed technology provides the magnetic tape cartridge according to the second aspect, in which the second fastening hole is formed at at least one of the positions corresponding to the four corners of the housing.

A fourth aspect according to the present disclosed technology provides the magnetic tape cartridge according to the second aspect, in which the second fastening hole is formed at any one of the positions corresponding to the four corners of the housing.

A fifth aspect according to the present disclosed technology provides the magnetic tape cartridge according to the third aspect, in which the second fastening hole is formed at a position that is separated from the first fastening hole by a predetermined distance.

A sixth aspect according to the present disclosed technology provides the magnetic tape cartridge according to the third aspect, in which the second fastening hole is formed at a corner that is diagonally opposite to a corner at which a contactless type communication medium is accommodated in the housing.

A seventh aspect according to the present disclosed technology provides the magnetic tape cartridge according to the first aspect, in which the method through which the second fastening member is attached is a one-way method in which the second fastening member is engaged with a tool only in a direction in which the second fastening member is tightened.

An eighth aspect according to the present disclosed technology provides the magnetic tape cartridge according to the first aspect, in which a cap member is attached to the second fastening hole to which the second fastening member has not been attached.

A ninth aspect according to the present disclosed technology provides a manufacturing method of a magnetic tape cartridge including a case that is a housing in which a magnetic tape is accommodable and of which a first case member and a second case member are fastenable to each other to form an internal space, the method including forming a first fastening hole to which a first fastening member fastening the first case member and the second case member to each other is attached and forming a second fastening hole to which a second fastening member that fastens the first case member and the second case member to each other for suppression of decomposition of the case is attachable through a method different from a method through which the first fastening member is attached.

A tenth aspect according to the present disclosed technology provides the manufacturing method of a magnetic tape cartridge according to the ninth aspect, further including attaching the first fastening member to the first fastening hole to fasten the first case member and the second case member to each other and selecting whether to attach the second fastening member to the second fastening hole.

### BRIEF DESCRIPTION OF THE DRAWINGS

FIG. 1 is a schematic perspective view showing an example of the appearance of a magnetic tape cartridge according to an embodiment.

FIG. 2 is a schematic perspective view showing an example of the appearance of the magnetic tape cartridge according to the embodiment.

FIG. 3 is a schematic perspective view showing an example of the appearance of the magnetic tape cartridge according to the embodiment.

FIG. 4 is a schematic perspective view showing an example of the appearance of the magnetic tape cartridge according to the embodiment.

FIG. 5 is a schematic perspective view showing an example of the appearance of a fastening member according to the embodiment.

FIG. 6 is a flowchart showing an example of an attachment step of the fastening member according to the embodiment.

FIG. 7 is a schematic perspective view showing an example of the appearance of a fastening member according to an embodiment.

FIG. 8 is a schematic perspective view showing an example of the appearance of a magnetic tape cartridge according to an embodiment.

### DETAILED DESCRIPTION

First, the terms used in the following description will be described.

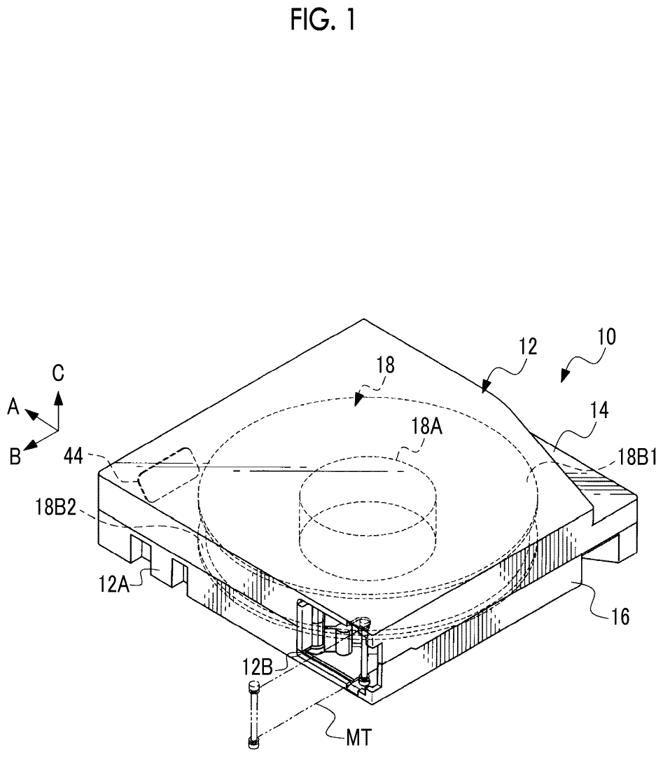

In the following description, for convenience of description, a direction along an arrow A in FIGS. 1 to 4 will be referred to as a frontward direction with respect to a magnetic tape cartridge 10 and a side to which the frontward direction with respect to the magnetic tape cartridge 10 extends will be referred to as a front side with respect to the magnetic tape cartridge 10. In the following description on the structure of the magnetic tape cartridge 10, “front” means the front side with respect to the magnetic tape cartridge 10.

In addition, in the following description, for convenience of description, a direction opposite to the frontward direction with respect to the magnetic tape cartridge 10 in FIGS. 1 to 4 will be referred to as a rearward direction with respect to the magnetic tape cartridge 10 and a side to which the rearward direction with respect to the magnetic tape cartridge 10 extends will be referred to as a rear side with respect to the magnetic tape cartridge 10. In the following description on the structure of the magnetic tape cartridge 10, “rear” means the rear side with respect to the magnetic tape cartridge 10.

In addition, in the following description, for convenience of description, a direction along an arrow B, which is orthogonal to the direction along the arrow A, in FIGS. 1 to 4 will be referred to as a rightward direction, and a side to which the rightward direction with respect to the magnetic tape cartridge 10 extends will be referred to as a right side with respect to the magnetic tape cartridge 10. In the following description on the structure of the magnetic tape cartridge 10, “right” means the right side with respect to the magnetic tape cartridge 10.

In addition, in the following description, for convenience of description, a direction opposite to the rightward direction with respect to the magnetic tape cartridge 10 in FIGS. 1 to 4 will be referred to as a leftward direction with respect to the magnetic tape cartridge 10, and a side to which the leftward direction of the magnetic tape cartridge 10 extends will be referred to as a left side with respect to the magnetic tape cartridge 10. In the following description on the structure of the magnetic tape cartridge 10, “left” means the left side with respect to the magnetic tape cartridge 10.

In addition, in the following description, for convenience of description, a direction orthogonal to the direction along the arrow A and the direction along the arrow B is represented by an arrow C in FIGS. 1 to 4, a direction along the arrow C will be referred to as an upward direction with respect to the magnetic tape cartridge 10, and a side to which the upward direction with respect to the magnetic tape cartridge 10 extends will be referred to as an upper side with respect to the magnetic tape cartridge 10. In the following description on the structure of the magnetic tape cartridge 10, “upper” means the upper side with respect to the magnetic tape cartridge 10.

In addition, in the following description, for convenience of description, a direction opposite to the upward direction with respect to the magnetic tape cartridge 10 in FIGS. 1 to 4 will be referred to as a downward direction with respect to the magnetic tape cartridge 10, and a side to which the downward direction of the magnetic tape cartridge 10 extends will be referred to as a lower side with respect to the magnetic tape cartridge 10. In the following description on the structure of the magnetic tape cartridge 10, “lower” means the lower side with respect to the magnetic tape cartridge 10.

For example, as shown in FIG. 1, the magnetic tape cartridge 10 includes a case 12 that is rectangular as seen in a plan view (that is, as seen in a normal direction of an upper surface 12D) and that has a box-like shape. In other words, the case 12 is a housing that has a square shape as seen in a plan view or that has a rectangular parallelepiped shape. The magnetic tape cartridge 10 is an example of a “magnetic tape cartridge” according to the present disclosed technology. The case 12 is formed of resin, such as polycarbonate, and includes an upper case 14 and a lower case 16. The upper case 14 and the lower case 16 are fastened by being screwed in a state where a lower peripheral edge surface of the upper case 14 and an upper peripheral edge surface of the lower case 16 are in contact with each other. Details of the way in which the cases are fastened by being screwed will be described later. In addition, the upper case 14 and the lower case 16 may be bonded to each other by being screwed and welded (through ultrasonic welding, for example). The case 12 is an example of a “case” according to the present disclosed technology. The upper case 14 is an example of a “first case member” according to the present disclosed technology, and the lower case 16 is an example of a “second case member” according to the present disclosed technology.

Inside the case 12, a cartridge reel 18 is rotatably accommodated. In other words, the cartridge reel 18 is accommodated in a space formed by the upper case 14 and the lower case 16. The cartridge reel 18 includes a reel hub 18A, an upper flange 18B1, and a lower flange 18B2. The reel hub 18A is formed in a cylindrical shape. The reel hub 18A is an axial portion of the cartridge reel 18, has an axial direction extending along an up-down direction of the case 12, and is disposed at a center portion of the case 12. Each of the upper flange 18B1 and the lower flange 18B2 is formed in an annular shape. A center portion of the upper flange 18B1 as seen in a plan view is fixed to an upper end portion of the reel hub 18A, and a center portion of the lower flange 18B2 as seen in a plan view is fixed to a lower end portion of the reel hub 18A. A magnetic tape MT is wound around an outer peripheral surface of the reel hub 18A, and an end portion of the magnetic tape MT in a width direction is held by the upper flange 18B1 and the lower flange 18B2. The reel hub 18A and the lower flange 18B2 may be molded integrally.

An opening 12B is formed on a rear side of a right wall 12A of the case 12. The magnetic tape MT is pulled out through the opening 12B. The magnetic tape MT is an example of a “magnetic tape” according to the present disclosed technology. In addition, a cartridge memory 44 is accommodated in a right front corner 13A of the case 12. An integrated circuit (IC) chip (not shown) including a non-volatile memory (NVM) is installed in the cartridge memory 44. In the present embodiment, a so-called passive radio frequency identifier (RFID) tag is adopted as the cartridge memory 44, and various kinds of information are read and written with respect to the cartridge memory 44 in a contactless manner. Specifically, information is read and written with respect to the cartridge memory 44 with a magnetic field penetrating the cartridge memory 44. The cartridge memory 44 is an example of a “contactless type communication medium” according to the present disclosed technology.

The cartridge memory 44 stores management information for management of the magnetic tape cartridge 10. The management information includes, for example, information on the cartridge memory 44 (for example, information with which it is possible to specify the magnetic tape cartridge 10) and information on the magnetic tape MT (for example, information indicating the storage capacity of the magnetic tape MT, information indicating the outline of data recorded in the magnetic tape MT, information indicating items of data recorded in the magnetic tape MT, information indicating a recording format of data recorded in the magnetic tape MT, and the like).

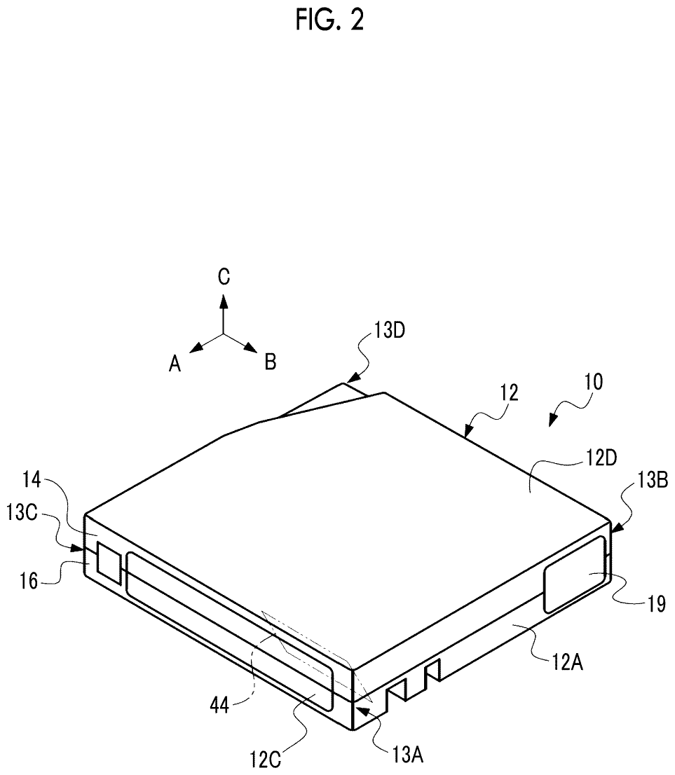

For example, as shown in FIG. 2, a label for identification of the magnetic tape cartridge 10 may be provided on a surface of the case 12 of the magnetic tape cartridge 10. In an example shown in FIG. 2, the label can be pasted onto a surface of a front wall 12C of the case 12. The label has, for example, a rectangular shape of which a longer side extends along a longitudinal direction of the front wall 12C of the case 12. For example, a barcode and a character string are on the label as an identifier.

A cover 19 that covers the opening 12B is provided on the rear side of the right wall 12A of the case 12. In a state where the magnetic tape cartridge 10 is not used, the cover 19 is closed so that the magnetic tape MT is not drawn out from the case 12.

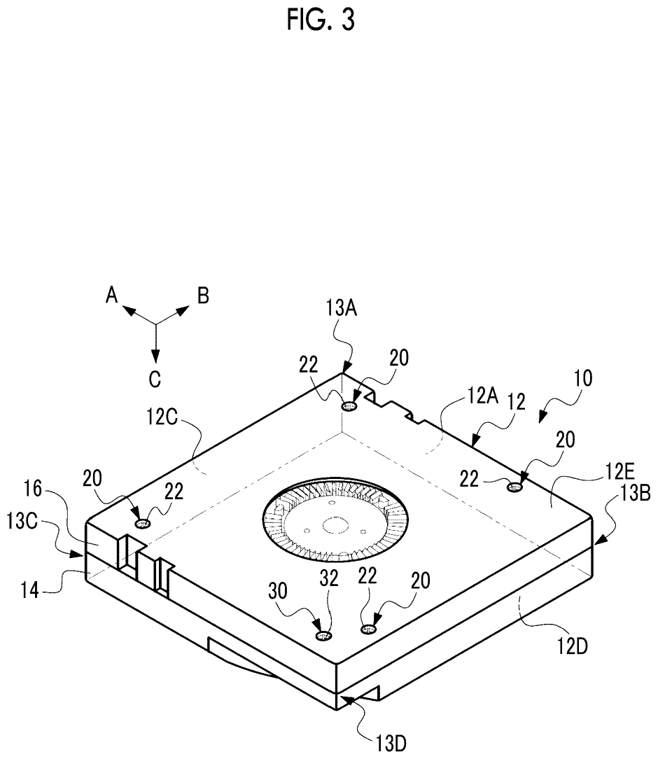

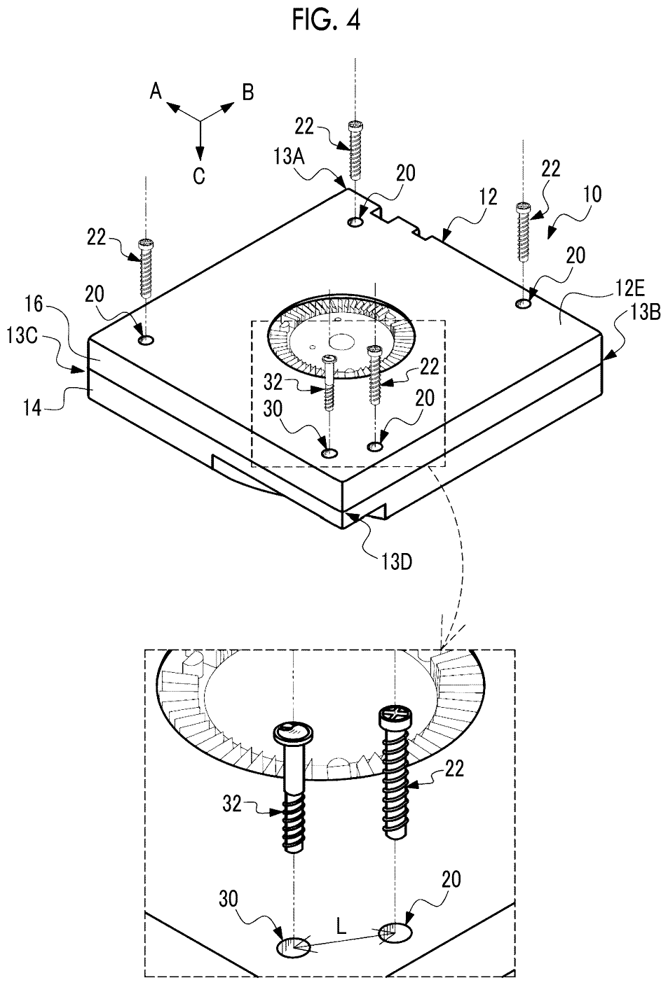

For example, as shown in FIGS. 3 and 4, a plurality of first fastening holes 20 are formed in a lower surface 12E of the case 12. In an example shown in FIG. 3, four first fastening holes 20 are formed. The plurality of first fastening holes 20 are provided such that at least one first fastening hole 20 is provided at each of positions corresponding to the four corners of the case 12. In the example shown in FIG. 3, one first fastening hole 20 is provided at each of the positions corresponding to the four corners of the case 12. Specifically, one first fastening hole 20 is provided at each of positions corresponding to the right front corner 13A, a right rear corner 13B, a left front corner 13C, and a left rear corner 13D of the case 12. The first fastening hole 20 is an example of a “first fastening hole” according to the present disclosed technology.

Here, each of the positions corresponding to the four corners refers to a position in an area that is set in advance centered on one of the four corners as seen in a plan view of the case 12 and that is closer to one corner than the midpoint between the one corner and another corner adjacent to the one corner. Positions where the first fastening holes 20 are provided are appropriately set in accordance with the structure and/or the design strength of the case 12 as long as the positions correspond to the four corners.

The first fastening holes 20 are formed from the lower case 16 to the upper case 14. A first fastening member 22 is attached to each first fastening hole 20. Each first fastening member 22 is inserted from the lower case 16 to the upper case 14 and mechanically bonds the lower case 16 and the upper case 14 to each other. Accordingly, the upper case 14 and the lower case 16 are fastened to each other. The first fastening member 22 is an example of a “first fastening member” according to the present disclosed technology.

Examples of the first fastening member 22 include a screw of which a head portion is provided with a cross-shaped hole serving as a driving hole. The first fastening member 22 is made of, for example, metal. In this case, the first fastening member 22 is attached to the first fastening hole 20 by using an electric Phillips screwdriver or an electric flat-blade screwdriver.

Meanwhile, various pieces of information are recorded on the magnetic tape MT in the magnetic tape cartridge 10, and the information is read and written as necessary. The pieces of information may include information of which the confidentiality level is high. Therefore, various units for suppression of the unauthorized reading and writing of information with respect to the magnetic tape cartridge 10 have been examined. However, in the magnetic tape cartridge 10, in a case where the entire cartridge reel 18 around which the magnetic tape MT is wound is replaced, the magnetic tape MT can be falsified. Therefore, it is required to suppress decomposition of the magnetic tape cartridge 10.

Therefore, in addition to the first fastening holes 20, a second fastening hole 30 is formed in the lower surface 12E of the case 12. In an example shown in FIG. 3, one second fastening hole 30 is formed. The second fastening hole 30 is provided at any one of positions corresponding to the four corners of the case 12. In the example shown in FIG. 3, the second fastening hole 30 is provided at a position corresponding to the left rear corner 13D among the four corners of the case 12. The second fastening hole 30 is an example of a “second fastening hole” according to the present disclosed technology.

The left rear corner 13D of the case 12 is positioned diagonally opposite to the right front corner 13A in which the cartridge memory 44 is stored. That is, the second fastening hole 30 is provided at a corner of the case 12 that is diagonally opposite to a corner in which the cartridge memory 44 is stored. Here, the expression “being provided at a diagonally opposite corner” means being provided in an area that is set in advance centered on the diagonally opposite corner as seen in a plan view of the case 12 and being provided closer to the diagonally opposite corner than the midpoint between the diagonally opposite corner and another corner adjacent to the diagonally opposite corner.

In addition, the second fastening hole 30 is formed at a position that is separated from the first fastening hole 20 by a predetermined distance L. Here, the distance L is a distance between the center of the second fastening hole 30 and the center of the first fastening hole 20. The distance L is equal to or larger than 5 mm. In addition, the upper limit of the distance L is set as appropriate in consideration of an area in which the first fastening hole 20 and the second fastening hole 30 can be disposed, the efficiency of a fastening work, and the like. For example, the distance L is equal to or smaller than 15 mm.

The second fastening hole 30 is formed from the lower case 16 to the upper case 14. A second fastening member 32 is attached to the second fastening hole 30. The second fastening member 32 is attached to the second fastening hole 30 through a method different from a method through which the first fastening member 22 is attached. The second fastening member 32 is an example of a “second fastening member” according to the present disclosed technology.

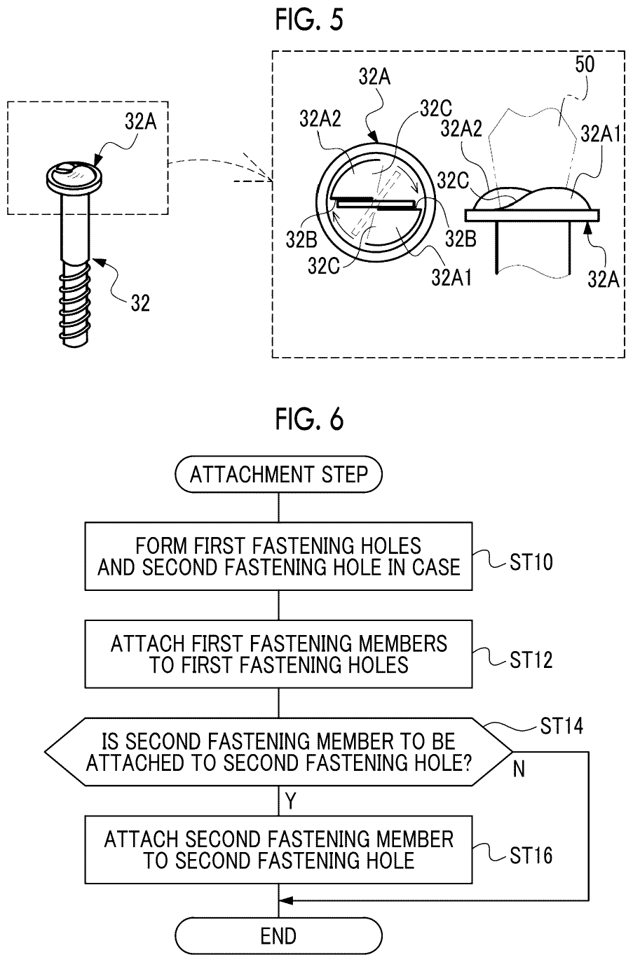

For example, as shown in FIG. 5, the second fastening member 32 is attached through a one-way method in which the second fastening member 32 is engaged with a tool only in a direction in which the second fastening member 32 is tightened. In an example shown in FIG. 5, the second fastening member 32 is a screw that is attached through the one-way method. In addition, the second fastening member 32 is made of, for example, metal. Specifically, a first engagement portion 32A1 and a second engagement portion 32A2 are formed at a head portion 32A of the second fastening member 32. The first engagement portion 32A1 and the second engagement portion 32A2 are mountain-shaped portions that protrude upward at the head portion 32A. The first engagement portion 32A1 and the second engagement portion 32A2 are disposed at positions that are point-symmetric as seen in a plan view of the head portion 32A.

Each of the first engagement portion 32A1 and the second engagement portion 32A2 has a flat surface 32B and an inclined surface 32C. The flat surface 32B is a surface that comes into contact with a tool 50 in a case where the tool 50 is rotated in the direction in which the second fastening member 32 is tightened. In addition, the inclined surface 32C is a surface that displaces the tool 50 in a direction away from the head portion 32A in a case where the tool 50 is rotated in a direction in which the second fastening member 32 is loosened. Here, the tool 50 may be a tool common to a tool used in a case where the first fastening member 22 is to be attached.

Therefore, in a case where the tool 50 (here, a flat-blade screwdriver) is rotated in the direction (here, a clockwise direction) in which the second fastening member 32 is tightened, the tool 50 comes into contact with the flat surface 32B. Then, a rotational force (that is, a torque) from the tool 50 is transmitted to the second fastening member 32, and the second fastening member 32 is attached to the second fastening hole 30. On the other hand, in a case where the tool 50 is rotated in the direction (here, a counterclockwise direction) in which the second fastening member 32 is loosened, the tool 50 moves along the inclined surface 32C. Therefore, the tool 50 is moved in a direction (that is, an upward direction) away from the head portion 32A and thus it is not possible to loosen the second fastening member 32 by using the tool 50. As described above, the second fastening member 32 is attached to the second fastening hole 30 through the one-way method in which the second fastening member 32 is engaged with a tool only in a direction in which the second fastening member 32 is tightened.

Here, as described above, the first fastening member 22 is fastened, via a cross-shaped hole provided at a head portion, by means of a tool such as a flat-blade screwdriver. In addition, the first fastening member 22 can be loosened, via the cross-shaped hole, by means of a tool such as a flat-blade screwdriver. That is, the first fastening member 22 can be engaged with the same tool in both a direction in which the first fastening member 22 is tightened and a direction in which the first fastening member 22 is loosened. Meanwhile, since the second fastening member 32 is a one-way type fastening member, the second fastening member 32 can be engaged with the same tool in a direction in which the second fastening member 32 is tightened but the second fastening member 32 cannot be engaged with the same tool in a direction in which the second fastening member 32 is loosened. As described above, the first fastening member 22 and the second fastening member 32 are attached through methods different from each other.

In addition, in order to detach the second fastening member 32, it is necessary to prepare a tool (for example, a dedicated tool for detachment of the second fastening member 32) different from a tool that is used in a case where the second fastening member 32 is to be attached. Therefore, it is difficult to detach the second fastening member 32. Accordingly, in a case where the second fastening member 32 is attached to the second fastening hole 30, decomposition of the case 12 is suppressed.

Next, an attachment step (hereinafter, may be simply referred to as an “attachment step”) of attaching the first fastening members 22 and the second fastening member 32 to the case 12 in the present embodiment will be described with reference to FIG. 6. FIG. 6 shows an example of the attachment step in the present embodiment. The attachment step is performed as a part of a step of manufacturing of the magnetic tape cartridge 10. Note that the attachment step shown in FIG. 6 is an example of a “manufacturing method of a magnetic tape cartridge” according to the present disclosed technology.

For example, regarding the attachment step shown in FIG. 6, first, in step ST10, the first fastening holes 20 and the second fastening hole 30 are formed in the case 12 of the magnetic tape cartridge 10. Thereafter, the attachment step proceeds to step ST12.

In step ST12, the first fastening members 22 are attached to the first fastening holes 20 in the magnetic tape cartridge 10. Thereafter, the attachment step proceeds to step ST14.

In step ST14, whether to attach the second fastening member 32 to the second fastening hole 30 is selected. In a case where attaching the second fastening member 32 to the second fastening hole 30 is not selected in step ST14, the attachment step ends since the result of determination in step ST14 is negative. In a case where attaching the second fastening member 32 to the second fastening hole 30 is selected in step ST14, the attachment step proceeds to step ST16 since the result of determination in step ST14 is positive.

In step ST16, the second fastening member 32 is attached to the second fastening hole 30 in the magnetic tape cartridge 10. Thereafter, the attachment step ends.

As described above, in the case of the magnetic tape cartridge 10 according to the present embodiment, the magnetic tape MT is accommodated in the case 12. In addition, the case 12 includes the upper case 14 and the lower case 16, and the upper case 14 and the lower case 16 are fastened to each other to form an internal space. The first fastening holes 20 to which the first fastening members 22 are attached are formed in the lower surface 12E of the case 12. The first fastening members 22 fasten the upper case 14 and the lower case 16 to each other. Furthermore, the second fastening hole 30 to which the second fastening member 32 is attachable is formed in the lower surface 12E of the case 12. The second fastening member 32 fastens the upper case 14 and the lower case 16 to each other.

In the case of the present configuration, since the second fastening hole 30, to which the second fastening member 32 is attachable through a method different from a method through which the first fastening members 22 are attached, is formed, it is possible to selectively impart a decomposition suppressing effect in accordance with the needs of a user. That is, in a case where the decomposition suppressing effect with respect to the case 12 is to be improved, the second fastening member 32 is attached to the second fastening hole 30. Meanwhile, in a case where a decomposition suppressing effect with respect to the general case 12 will suffice, the second fastening hole 30 is not used. That is, the second fastening member 32 is not attached to the second fastening hole 30. In this manner, it is possible to selectively impart a decomposition suppressing effect in accordance with the needs of a user.

In addition, at the time of decomposition, it is necessary to prepare two or more types of tools for the decomposition since the second fastening member 32 that is attached through a method different from a method through which the first fastening member 22 is attached is used. For example, in the case of a one-way type screw, it is necessary to prepare a dedicated tool instead of a driver used to tighten a normal screw. Therefore, since decomposition of the case 12 is suppressed and thus falsification of the magnetic tape MT accommodated in the magnetic tape cartridge 10 is suppressed.

For example, an environment in which the magnetic tape cartridge 10 is used in various environments including a place where the level of interest in information security is high like a data center, a government office, or a large company and a place where the level of interest in information security is relatively low like a private enterprise or a small and medium-sized business. Therefore, consciousness about a risk of decomposition and falsification of the magnetic tape cartridge 10 differs depending on a user. In the case of the present configuration, it is possible to suppress falsification of the magnetic tape cartridge 10 by attaching the second fastening member 32 to the second fastening hole 30. Therefore, it is possible to provide an information security function for the magnetic tape cartridge 10 that meets the needs of a user. That is, by selecting whether to attach the second fastening member 32 in a manufacturing stage in accordance with the needs of the user, it is possible to change the level of security.

For example, the first fastening member 22 is attached to the first fastening hole 20 in advance to assemble the case 12 and the second fastening member 32 is attached to the second fastening hole 30 in a subsequent step (for example, an adjustment step before shipment) in accordance with the needs of the user. In this case, it is possible to selectively impart a decomposition suppressing effect with respect to the magnetic tape cartridge 10 in accordance with the needs of a user, without reducing the productivity of the magnetic tape cartridge 10.

In addition, in the magnetic tape cartridge 10 according to the present embodiment, the plurality of first fastening holes 20 are formed in the case 12. In addition, one first fastening hole 20 is provided at each of the four corners of the case 12 as seen in a plan view of the case 12 having a rectangular shape. Accordingly, the upper case 14 and the lower case 16 are fastened to each other at the four corners of the case 12 and thus the fastening strength of the case 12 is secured. In other words, from the viewpoint of the fastening strength of the case 12 of the magnetic tape cartridge 10, the second fastening member 32 does not need to be used and thus use of the second fastening member 32 can be an option used in accordance with the needs of a user.

In addition, as described above, the magnetic tape MT is accommodated in the magnetic tape cartridge 10 in a state of being wound around the cartridge reel 18. That is, an object having a circular shape as seen in a plan view is accommodated in the magnetic tape cartridge 10. Therefore, there is a relatively large space at each of the four corners of the case 12 of the magnetic tape cartridge 10 and thus it is easy to dispose the first fastening holes 20.

In addition, in the magnetic tape cartridge 10 according to the present embodiment, the second fastening hole 30 of the case 12 is provided at at least one of the positions corresponding to the four corners. For example, the second fastening hole 30 is provided at a position corresponding to the left rear corner 13D of the case 12. Accordingly, as with the first fastening holes 20, the second fastening hole 30 is provided at positions corresponding to the four corners of the case 12. Therefore, the position of the second fastening hole 30 can be easily grasped, and thus a fastening work is facilitated.

In addition, in the magnetic tape cartridge 10 according to the present embodiment, the second fastening hole 30 of the case 12 is provided at any one of the positions corresponding to the four corners in the case 12. For example, the second fastening hole 30 is provided at a position corresponding to the left rear corner 13D of the case 12. Accordingly, a decomposition suppressing effect with respect to the case 12 is secured and the productivity of the magnetic tape cartridge 10 is improved since it is not necessary to provide the second fastening hole 30 which is not necessary.

In addition, in the magnetic tape cartridge 10 according to the present embodiment, the second fastening hole 30 of the case 12 is formed at a position that is separated from the first fastening hole 20 by the predetermined distance L. For example, in a case where a distance between the second fastening hole 30 and the first fastening hole 20 is smaller than the predetermined distance L, the strength of a portion between the holes is made low since the second fastening hole 30 is close to the first fastening hole 20. In the case of the present configuration, since the second fastening hole 30 is formed at a position that is separated from the first fastening hole 20 by the predetermined distance L, a decrease in strength of the case 12 is suppressed.

In addition, there is a case where the case 12 of the magnetic tape cartridge 10 is manufactured by means of injection molding in which a mold is used. In this case, the mold is provided with a protruding portion for the molding of the first fastening hole 20 and a protruding portion for the molding of the second fastening hole 30. In the case of the present configuration, the second fastening hole 30 of the case 12 is designed to be at a position that is separated from the first fastening hole 20 by the predetermined distance L. That is, at the mold as well, the protruding portion for the molding of the first fastening hole 20 and the protruding portion for the molding of the second fastening hole 30 are provided at positions that are separated from each other by the predetermined distance L. In a case where the protruding portions of the mold are close to each other, the thickness of a portion between the protruding portions is made small due to the design of the mold. In the case of the present configuration, since the second fastening hole 30 of the case 12 is designed to be at a position that is separated from the first fastening hole 20 by the predetermined distance L, the distance between the protruding portions of the mold is also secured and thus the thickness of the portion between the protruding portions of the mold is secured, which contributes to improvement of the life.

In addition, in the magnetic tape cartridge 10 according to the present embodiment, the second fastening hole 30 of the case 12 is formed at the left rear corner 13D that is diagonally opposite to the right front corner 13A in which the cartridge memory 44 is stored. In the case 12, generally, there is a large space at the left rear corner 13D in comparison with other corners and thus the second fastening hole 30 can be easily disposed, the left rear corner 13D being diagonally opposite to the right front corner 13A in which the cartridge memory 44 is stored. That is, the cartridge memory 44 is stored in the right front corner 13A, and the opening 12B through which the magnetic tape MT is drawn out and the cover 19 that covers the opening 12B are provided at the right rear corner 13B (refer to FIG. 2). In addition, a mechanism for suppression of overwriting on the magnetic tape MT is provided at the left front corner 13C. Therefore, there is a large space at the left rear corner 13D of the case 12 in comparison with the other corners and thus the second fastening hole 30 can be easily disposed.

In addition, the second fastening member 32 is generally formed of metal from the viewpoint of dimensional accuracy or manufacturing cost. Since the second fastening member 32 made of metal is disposed at a corner diagonally opposite to the right front corner 13A in which the cartridge memory 44 is stored, it is possible to lower a probability that the second fastening member 32 interferes with a magnetic field penetrating the cartridge memory 44 for the reading and writing of information.

In addition, in the magnetic tape cartridge 10 according to the present embodiment, a method through which the second fastening member 32 is attached is a one-way method in which the second fastening member 32 is engaged with a tool only in a direction in which the second fastening member 32 is tightened. Accordingly, a decomposition suppressing effect is improved.

In addition, in the case of the one-way method, even in a case where the second fastening member 32 is automatically tightened by means of an electric driver, the second fastening member 32 can be tightened with the same tool distal end shape as a tool distal end shape for the first fastening member 22 and at the same torque as a torque for the first fastening member 22 and thus deterioration on the tool side (for example, damage to a tool distal end) is suppressed.

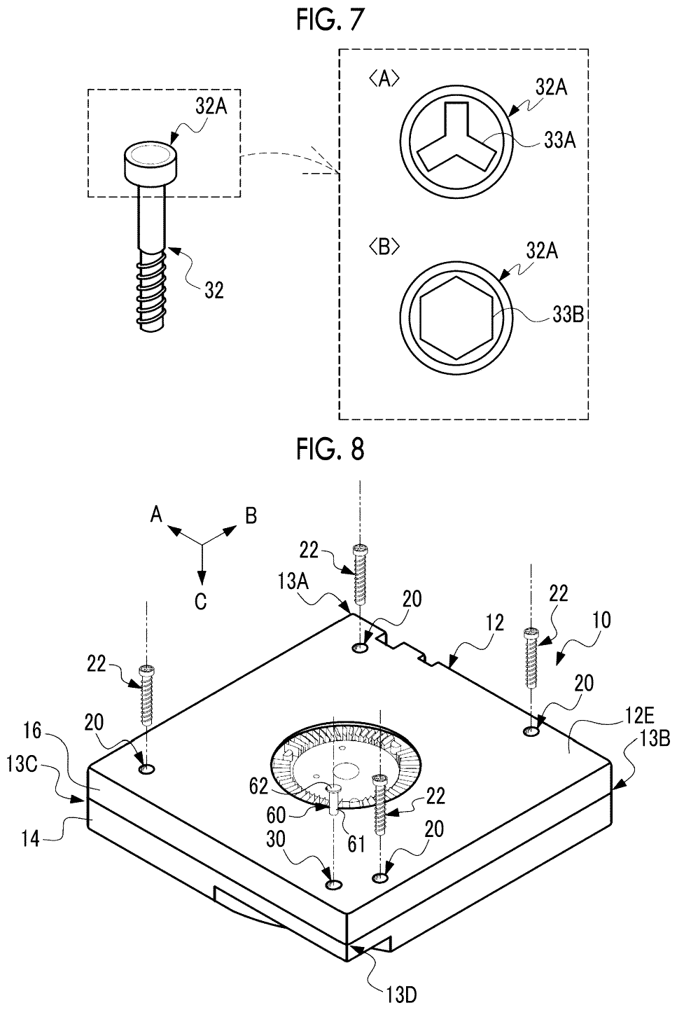

In the embodiment described above, an example in which the second fastening member 32 is a one-way type fastening member has been described, but the present disclosed technology is not limited thereto. For example, as shown in <A> of FIG. 7, the second fastening member 32 may be a fastening member of which the head portion 32A is provided with a Y-shaped driving hole 33A as seen in a plan view of the head portion 32A. In this case, the second fastening member 32 can be fastened or loosened by using a tool of which a distal end has a Y-like shape. That is, in a case where the first fastening member 22 is a general screw, it is necessary to prepare a driver for the first fastening member 22 and to prepare another tool for the second fastening member 32. Therefore, a decomposition suppressing effect with respect to the case 12 can be obtained because of the second fastening member 32.

In addition, as shown in <B> in FIG. 7 as another example, in a case where the head portion 32A of the second fastening member 32 is viewed in a plan view, the head portion 32A may be a fastening member in which a hexagonal driving hole 33B is formed. In this case, the second fastening member 32 can be fastened or loosened by using a tool having a hexagonal front end. That is, in a case where the first fastening member 22 is a general screw, it is necessary to prepare a driver for the first fastening member 22 and to prepare another tool for the second fastening member 32. Therefore, a decomposition suppressing effect with respect to the case 12 can be obtained because of the second fastening member 32.

### Modification Example

In the embodiment described above, an example in which the second fastening member 32 is attached to the second fastening hole 30 has been described. However, the second fastening member 32 may not be attached in accordance with the user's needs related to the confidentiality level of the magnetic tape cartridge 10.

For example, as shown in FIG. 8, one first fastening hole 20 is provided at each of the positions corresponding to the four corners of the case 12. The first fastening member 22 is attached to each first fastening hole 20. In addition, the second fastening hole 30 is provided at a position corresponding to one of the four corners of the case 12. Here, a cap member 60 is attached to the second fastening hole 30. The cap member 60 is an example of a “cap member” according to the present disclosed technology.

The cap member 60 is a member that can close the second fastening hole 30. In an example shown in FIG. 8, the cap member 60 is a cylindrical member and includes a body portion 61 that is inserted into the second fastening hole 30 and a head portion 62 that is provided at an upper end of the body portion 61. The head portion 62 has a disk-shaped portion that is larger than an inner diameter of the second fastening hole 30. Since the cap member 60 is attached to the second fastening hole 30, the second fastening hole 30 is closed. The cap member 60 is made of, for example, resin.

As described above, in the present modification example, the cap member 60 is attached to the second fastening hole 30 to which the second fastening member 32 has not been attached. Accordingly, a foreign matter is restrained from infiltrating into the second fastening hole 30 that is not in use. For example, even in a case where the second fastening member 32 is not attached in accordance with the user's needs related to the level of confidentiality of the magnetic tape cartridge 10, a foreign matter can be restrained from infiltrating into the magnetic tape cartridge 10 through the second fastening hole 30.

In the above-described embodiment, although a form example where one first fastening hole 20 is provided at a position corresponding to each of the four corners of the case 12 has been described, the present disclosed technology is not limited thereto. For example, two first fastening holes 20 may be provided at positions corresponding to each of the four corners of the case 12. In addition, the first fastening hole 20 may be provided at a location other than the four corners of the case 12.

In addition, in the embodiment described above, an example in which one second fastening hole 30 is provided at a position corresponding to any one of the four corners of the case 12 has been described. However, the present disclosed technology is not limited thereto. For example, one second fastening hole 30 may be provided at each of positions corresponding to two or more corners of the case 12. In addition, for example, two second fastening holes 30 may be provided at positions corresponding to corners of the case 12. In addition, the second fastening hole 30 may be provided at a place other than the corners of the case 12.

In addition, in the embodiment described above, an example in which one first fastening hole 20 is provided for each of positions corresponding to the four corners of the case 12 has been described. However, the present disclosed technology is not limited thereto. For example, a configuration in which the first fastening hole 20 is provided at one, two, or three of the four corners of the case 12 and the second fastening hole 30 is provided at the remaining corner may also be adopted.

In addition, in the embodiment described above, an example in which the first fastening hole 20 and/or the second fastening hole 30 is provided in the lower surface 12E of the case 12 has been described. However, the present disclosed technology is not limited thereto. For example, the first fastening hole 20 and/or the second fastening hole 30 may be provided in the upper surface 12D of the case 12.

The above-described contents and illustrated contents are detailed descriptions of parts related to the present disclosed technology and are merely examples of the present disclosed technology. For example, description of the above-described configurations, functions, actions, and effects is description related to an example of configurations, functions, actions, and effects of parts related to the present disclosed technology. Therefore, it is a matter of course that an unnecessary part of the contents described and illustrated above may be deleted, a new element may be added, and replacement may be made without departing from the spirit of the present disclosed technology. In addition, in order to avoid complication and facilitate the understanding of parts related to the present disclosed technology, regarding the contents described and illustrated above, description related to common technical knowledge or the like which does not need to be described to enable implementation of the present disclosed technology has been omitted.

In the present specification, “A and/or B” is synonymous with “at least one of A or B”. That is, “A and/or B” means “A, B, or a combination of A and B”. In addition, in the present specification, the same concept as in the case of “A and/or B” applies to a case where three or more matters are expressed together by “and/or”.

All publications, patent applications, and technical standards described in the present specification are incorporated herein by reference to the same extent as if each publication, patent application, or technical standard was specifically and individually indicated to be incorporated by reference.

In regard to the above-described embodiment, the following supplementary notes will be further disclosed.

### Supplementary Note 1

A magnetic tape cartridge including:
a magnetic tape; and
a case that is a housing of which a first case member and a second case member are fastened to each other to form an internal space in which a magnetic tape is accommodable, the case including a first fastening hole to which a first fastening member fastening the first case member and the second case member to each other is attached and a second fastening hole to which a second fastening member that is attached through a method different from a method through which the first fastening member is attached and that fastens the first case member and the second case member to each other for suppression of decomposition of the housing is attachable.

### Supplementary Note 2

The magnetic tape cartridge described in Supplementary Note 1,
in which a plurality of the first fastening holes are formed, and
at least one first fastening hole is formed at each of positions corresponding to four corners of the housing.

### Supplementary Note 3

The magnetic tape cartridge described in Supplementary Note 1 or 2,
in which the second fastening hole is formed at at least one of the positions corresponding to the four corners of the housing.

### Supplementary Note 4

The magnetic tape cartridge described in any one of Supplementary Notes 1 to 3,
in which the second fastening hole is formed at any one of the positions corresponding to the four corners of the housing.

### Supplementary Note 5

The magnetic tape cartridge described in any one of Supplementary Notes 1 to 4,
in which the second fastening hole is formed at a position that is separated from the first fastening hole by a predetermined distance.

### Supplementary Note 6

The magnetic tape cartridge described in any one of Supplementary Notes 1 to 5,
in which the second fastening hole is formed at a corner that is diagonally opposite to a corner at which a contactless type communication medium is accommodated in the housing.

### Supplementary Note 7

The magnetic tape cartridge described in any one of Supplementary Notes 1 to 6,
in which the method through which the second fastening member is attached is a one-way method in which the second fastening member is engaged with a tool only in a direction in which the second fastening member is tightened.

### Supplementary Note 8

The magnetic tape cartridge described in any one of Supplementary Notes 1 to 7,
in which a cap member is attached to the second fastening hole to which the second fastening member has not been attached.

### Supplementary Note 9

A manufacturing method of a magnetic tape cartridge including a case that is a housing in which a magnetic tape is accommodable and of which a first case member and a second case member are fastenable to each other to form an internal space, the method including:
forming a first fastening hole to which a first fastening member fastening the first case member and the second case member to each other is attached; and
forming a second fastening hole to which a second fastening member that fastens the first case member and the second case member to each other for suppression of decomposition of the case is attachable through a method different from a method through which the first fastening member is attached.

### Supplementary Note 10

The manufacturing method of a magnetic tape cartridge described in Supplementary Note 9, further including:
attaching the first fastening member to the first fastening hole to fasten the first case member and the second case member to each other; and
selecting whether to attach the second fastening member to the second fastening hole.

What is claimed is:

1. A magnetic tape cartridge comprising:
a magnetic tape; and
a case that is a housing of which a first case member and a second case member are fastened to each other to form an internal space in which a magnetic tape is accommodable, the case including a first fastening hole to which a first fastening member fastening the first case member and the second case member to each other is attached and a second fastening hole to which a second fastening member that is attached through a method different from a method through which the first fastening member is attached and that fastens the first case member and the second case member to each other for suppression of decomposition of the housing is attachable.

2. The magnetic tape cartridge according to claim 1,
wherein a plurality of the first fastening holes are formed, and
at least one first fastening hole is formed at each of positions corresponding to four corners of the housing.

3. The magnetic tape cartridge according to claim 2,
wherein the second fastening hole is formed at at least one of the positions corresponding to the four corners of the housing.

4. The magnetic tape cartridge according to claim 2,
wherein the second fastening hole is formed at any one of the positions corresponding to the four corners of the housing.

5. The magnetic tape cartridge according to claim 3,
wherein the second fastening hole is formed at a position that is separated from the first fastening hole by a predetermined distance.

6. The magnetic tape cartridge according to claim 3,
wherein the second fastening hole is formed at a corner that is diagonally opposite to a corner at which a contactless type communication medium is accommodated in the housing.

7. The magnetic tape cartridge according to claim 1,
wherein the method through which the second fastening member is attached is a one-way method in which the second fastening member is engaged with a tool only in a direction in which the second fastening member is tightened.

8. The magnetic tape cartridge according to claim 1,
wherein a cap member is attached to the second fastening hole to which the second fastening member has not been attached.

9. A manufacturing method of a magnetic tape cartridge including a case that is a housing in which a magnetic tape is accommodable and of which a first case member and a second case member are fastenable to each other to form an internal space, the method comprising:
forming a first fastening hole to which a first fastening member fastening the first case member and the second case member to each other is attached; and
forming a second fastening hole to which a second fastening member that fastens the first case member and the second case member to each other for suppression of decomposition of the case is attachable through a method different from a method through which the first fastening member is attached.

10. The manufacturing method of a magnetic tape cartridge according to claim 9, further comprising:
attaching the first fastening member to the first fastening hole to fasten the first case member and the second case member to each other; and
selecting whether to attach the second fastening member to the second fastening hole.
